(19) United States
(12) Patent Application Publication
(10) Pub. No.: US 2014/0064412 A1
(43) Pub. Date: Mar. 6, 2014

(54) High Performance Turbo DPSK

(71) Applicant: TEXAS INSTRUMENTS INCORPORATED, Dallas, TX (US)

(72) Inventors: Jing Lin, Austin, TX (US); Il Han Kim, Allen, TX (US); Tarkesh Pande, Richardson, TX (US); Anuj Batra, Dallas, TX (US)

(73) Assignee: TEXAS INSTRUMENTS INCORPORATED, Dallas, TX (US)

(21) Appl. No.: 14/015,728

(22) Filed: Aug. 30, 2013

Related U.S. Application Data
(60) Provisional application No. 61/695,166, filed on Aug. 30, 2012.

(51) Int. Cl. H04L 27/22

(52) U.S. Cl. CPC H04L 27/22
USPC 375/330

(57) ABSTRACT

A system includes a DPSK transmitter and a DPSK receiver. The DPSK transmitter is configured to encode a signal and transmit the encoded signal as a sequence of symbols. The DPSK receiver is configured to decode the sequence of symbols into bit values. The DPSK receiver further includes a first decoder which is configured to receive the sequence of the symbols, and to estimate extrinsic information for each symbol and forward the extrinsic information to a second decoder. Moreover, if magnitude of a LLR received form a second decoder is greater than a threshold, the first decoder is configured to determine a bit value of a received symbol, without considering neighboring symbols in the sequence of symbols. Still moreover, if the magnitude of the LLR received from the second decoder is not greater than the threshold, the first decoder is configured to continue to decode the received symbol and consider neighboring symbols in the sequence of symbols.

### CROSS-REFERENCE TO RELATED APPLICATION

The present application claims priority to U.S. Provisional Patent Application No. 61/695,166 filed on Aug. 30, 2012 (Attorney Docket No. TI-72816 PS); which is hereby incorporated herein by reference.

### BACKGROUND

Differentially phase shift keying (DPSK) is a popular digital modulation technique. A DPSK receiver recovers encoded information from a received signal by subtracting the phase of the previous symbol sample from the phase of current sample. However, compared to coherent phase shift keying (PSK), the DPSK suffers from performance degradation. In order to increase the performance of DPSK, while keeping bit error rate (BER) at a reasonable value, soft-input soft-output (SISO) multiple symbol differential sphere decoding (MSDSD) was proposed. MSDSD, however, is quite complex. Performance and/or the efficiency of the SISO MSDSD, or simply the receiver using the SISO MSDSD, may degrade aggressively with the size of an observation window.

### SUMMARY

Various systems and methods for improving performance of a turbo differential phase shift keying (DPSK) receiver are disclosed herein. In some embodiments, a DPSK receiver includes an inner decoder and an outer decoder. The inner decoder is configured to receive a sequence of symbols and to generate extrinsic information for each bit of the received symbol. The outer decoder, coupled to the inner decoder, is configured to generate a log-likelihood ratio (LLR) for each bit of the received symbol and to provide the LLR for each bit back to the inner decoder, by using the extrinsic information as a priori information for each bit. Further, the inner decoder determines a bit value for a bit of a received symbol without considering neighboring symbols in the sequence, if magnitude of the LLR for the received symbol is larger than a threshold.

In accordance with at least some embodiments, a system includes a DPSK transmitter and a DPSK receiver. The DPSK transmitter is configured to encode a signal and transmit the encoded signal as a sequence of symbols. The DPSK receiver is configured to decode the sequence of symbols into bit values. The DPSK receiver further includes a first decoder which is configured to receive the sequence of the symbols, and to estimate extrinsic information for each bit of the symbols and forward the extrinsic information to a second decoder. Moreover, if magnitude of a LLR received form a second decoder is greater than a threshold, the first decoder is configured to determine a bit value for a bit of a received symbol, without considering neighboring symbols in the sequence of symbols. Still moreover, if the magnitude of the LLR received from the second decoder is not greater than the threshold, the first decoder is configured to continue to decode the bit of the received symbol and consider neighboring symbols in the sequence of symbols.

In accordance with yet other embodiments, a method includes receiving, by an inner decoder of a DPSK receiver, a sequence of symbols, and calculating, by the inner decoder, extrinsic information for each bit and sending the extrinsic information to an outer decoder. The method further includes receiving, by the inner decoder, a LLR for each bit which is generated by the outer decoder and determining, by the inner decoder, a bit value for a bit of a received symbol without considering neighboring symbols in the sequence of symbols, if magnitude of the LLR for the bit of the received symbol is greater than a threshold.

### BRIEF DESCRIPTION OF THE DRAWINGS

For a detailed description of exemplary embodiments of the invention, reference will now be made to the accompanying drawings in which:

FIG. 1 shows a block diagram of an illustrative turbo coded communication system in accordance with various embodiments.

FIG. 2 shows a block diagram of a turbo differential phase shift keying (DPSK) receiver in accordance with various embodiments.

FIG. 3 shows an illustrative sequence of symbols for the turbo DPSK receiver in accordance with various embodiments.

FIG. 4 shows an illustrative search tree for the turbo DPSK receiver in accordance with various embodiments.

FIG. 5 shows a flow diagram for a method for determining a bit value of a symbol in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct electrical connection. Thus, if a first device couples to a second device, that connection may be through a direct connection, or through an indirect connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

In data communications, a receiver to implement turbo differential phase shift keying (DPSK) algorithm in receivers with soft-input soft-output (SISO) multiple symbol differential sphere decoding (MSDSD) has been proposed to alleviate performance loss from conventional DPSK receivers. Due to an extremely high complexity by using the SISO MSDSD in a turbo DPSK receiver, which may degrade performance of the receiver, a decoding algorithm used by the receiver with higher performance and efficiency is desirable.

Embodiments of the present disclosure improve performance of SISO MSDSD in a turbo DPSK receiver by making a hard decision on a bit of a received symbol upon reception of a high enough magnitude (e.g., in excess of a threshold) of a log-likelihood ratio (LLR) for the bit. Thus, embodiments disclosed herein include estimating the LLR and determining the hard decision. As will be shown below, such embodiments for a SISO MSDSD result in a more efficient and higher performance receiver.

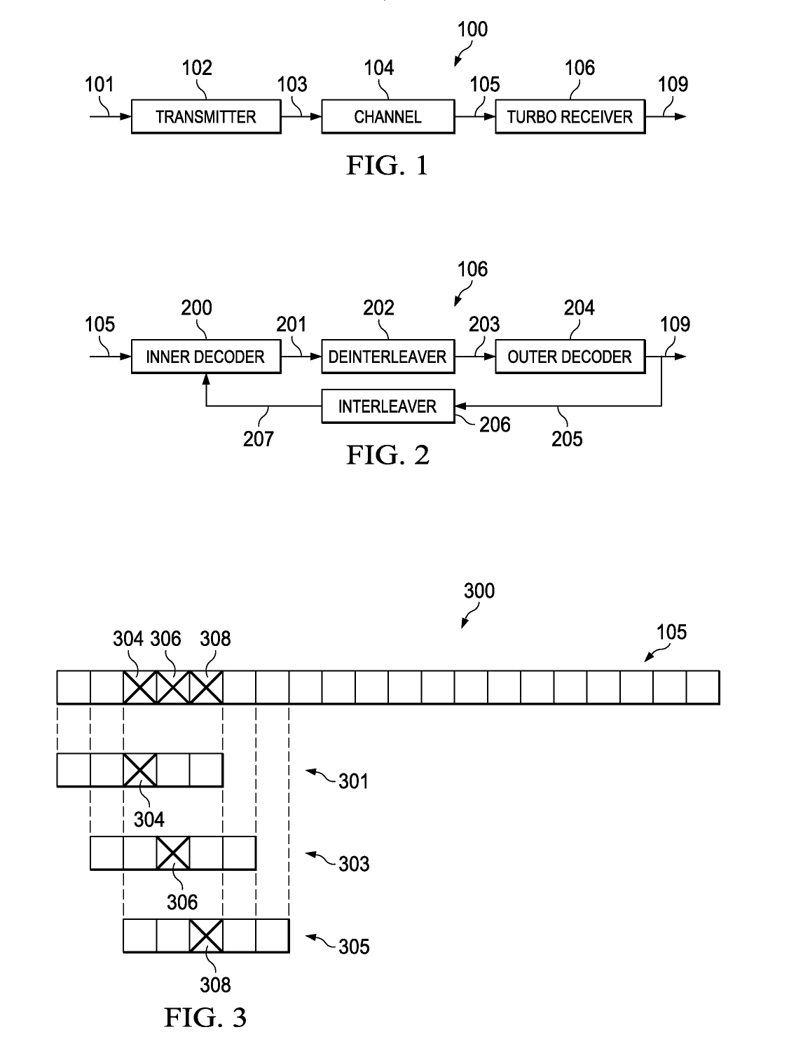

FIG. 1 shows a block diagram of an illustrative turbo coded communication system 100 in accordance with various embodiments. The system 100 includes a transmitter 102 and a turbo receiver 109 that communicate with each other via a communication channel 104. The transmitter 102, further comprising an encoder, an interleaver and a phase shift keying (PSK) mapper (not shown in FIG. 1), is configured to encode a bit sequence 101 into a sequence of symbols 103, and transmit the encoded symbols 103 via the communication channel 104 to the turbo receiver 106. Generally, the coded symbols 103 are subjected to noise and/or interference via the communication channel 104. In other words, a sequence of symbols 105 received by the turbo receiver 106 may be a “noisy” version of the transmitted sequence of symbols 103.

In some preferred embodiments, the encoder and the PSK mapper in the transmitter 102 may form a serially-concatenated coding system. Further, the encoder may be a convolutional encoder configured to encode the bit sequence 101, and the PSK mapper serially coupled to the encoder via the interleaver, may be an M-ary differential PSK encoder configured to differentially generate the sequence of symbols 103. M-ary differential PSK may refer to as a multi-level modulation technique to permit high data rates within fixed bandwidth constraints. M is typically an even integer.

Still referring to FIG. 1, once the sequence 105 is received by the turbo receiver 106, the turbo receiver 106 is configured to decode the sequence 105 in order to recover the coded sequence 103. The turbo receiver 106 utilizes a turbo decoding algorithm on the received sequence 105 to reconstruct the original bit sequence 101 as a sequence 109 for users' applications.

FIG. 2 shows a block diagram of the turbo DPSK receiver 106 in accordance with various embodiments. The turbo DPSK receiver 106 includes an inner decoder 200, a deinterleaver 202, an outer decoder 204, and an interleaver 206. The inner decoder 200 and the outer decoder 204 form an iterative loop, where the outer decoder 204 provides information 205 as a feedback or “turbo” signal to the inner decoder 200, via the interleaver 206. In some preferred embodiments, both the inner decoder 200 and the outer decoder 204 may use soft decision-making, that is, so called soft-input soft-output (SISO) modules. Generally, soft decision-making refers to a process in which data is evaluated using probability information relating to the data in order to generate a “candidate guess” as to the accuracy of the data.

More particularly, the inner decoder 200 and the outer decoder 204 provide extrinsic information (e.g., 201 and 205) about the coded symbols 105. The extrinsic information is used as a priori information by the respective other decoder. For example, the inner decoder 200 generates extrinsic information 201 and the outer decoder 204 uses the inner decoder's extrinsic information 201, after being deinterleaved by the deinterleaver 202, as a priori information 203 to the outer decoder 204. Similarly, extrinsic information 205 is generated by the outer decoder 204 and provided to the inner coder after being interleaved by interleaver 206. In some embodiments, the exchange of extrinsic information iterates for a certain number of times.

In some preferred embodiments, the inner decoder 200 may use a multiple symbol differential sphere decoding (MSDSD) algorithm to demodulate received symbols. A goal of the MSDSD algorithm is to increase efficiency by reducing computational complexity which grows exponentially with the length of the received sequence of symbols. The disclosed MSDSD algorithm preferably includes searching over only the received symbols that lie within a hypersphere of radius R around each received symbol. The MSDSD algorithm works well for power-efficient transmission over frequency-nonselective (flat) Rayleigh fading channels without the need for explicit channel phase and amplitude estimation at the receiver's end. More particularly, the disclosed MSDSD algorithm is based on estimating the corresponding objective function for each received symbol, and the objective function is deduced from the extrinsic information (e.g., 205), or a posterior probability. In some embodiments, the a posteriori probability is configured to be estimated by the outer decoder 204 and loops back as a priori information for the inner decoder 200. More particularly the a posteriori information generated by the outer decoder 204 includes the LLR for each bit of the symbols in the sequence 105. Generally, the LLR is defined as logarithm of a ratio of two likelihood functions, in which the likelihood functions are based on the a posteriori probabilities, generated by the outer decoder 204, for each bit to have a bit value or a compliment of the bit value. Further, the outer decoder 204 may use the Bahl-Cocke-Jelinek-Raviv (BCJR) algorithm in some preferred implementations in order to calculate the LLRs.

Combing SISO and the MSDSD algorithm to be used in an inner decoder of a turbo DPSK receiver leads to a higher performance DPSK receiver with a reasonable bit-error (BER) rate. However, use of the SISO MSDSD algorithm may result in a considerably high complexity receiver, potentially restricting applicability of the turbo DPSK receiver from practical implementations since the SISO MSDSD algorithm uses maximally overlapped windows to search a candidate bit value for a received symbol. Details are discussed below.

FIG. 3 shows an illustrative sequence of symbols 105 received by the turbo DPSK receiver 106 in accordance with various embodiments. The turbo DPSK receiver 106 is configured to decode and/or demodulate the encoded sequence of symbols 105, and reconstruct the original signal 101. The sequence of symbols may comprise a plurality of symbols. For example, the sequence of symbols 105 includes twenty symbols (e.g., 304, 306 and 308) and each symbol may be different or identical. In the SISO MSDSD algorithm used by the inner decoder 200, the maximally overlapped observation window needs to be searched for each symbol waiting to be decoded. The observation window, or simply the window, may be referred to as a virtual window comprising a shorter sequence of symbols than the sequence of symbols 105. The maximally overlapped window may be referred to as a plurality of consecutive windows overlapping each other but with only one different symbol. For each symbol to be decoded by the SISO MSDSD algorithm, the next m symbols and the previous n symbols (the “neighboring” symbols) relative to the current symbol to be decoded need to be estimated and more particularly, a posteriori probabilities for the current and neighboring symbols need to be calculated by the inner decoder 200. A value of m plus n is a size for an observation window. Subsequently, for a next symbol to be decoded, the same process repeats, albeit with the window having shifted by one symbol. In other words, the observation windows for adjacent symbols to be decoded overlaps. For example, in an illustrative step 301, symbol 304 is being decoded. The SISO MSDSD algorithm requires the information about the a posteriori probabilities for next two (i.e., m=2) symbols and previous two (i.e., n=2) symbols to be estimated, which means that the a posteriori probabilities for symbol 306 and 308 (next two symbols) has been estimated in the step 301. For symbol 308 to be decoded in an illustrative step 305, even though symbols 304 and 306 have already been decoded in steps 301 and 303, the a posterior probabilities for the symbol 304 and 306 still have to be calculated in the step 305. This maximally overlapped window used in the SISO MSDSD algorithm, in turn, may increase the complexity, and potentially limit the applicability of the receiver 106. Values of m and n may be predefined by the inner decoder 200 or the receiver 106.

In order to effectively reduce the complexity of the SISO MSDSD algorithm and render the receiver to be more efficient, embodiments disclosed herein use a hard decision-making, based on the LLR for each bit of symbols provided by the outer decoder, on each bit of the symbols to be decoded instead of the maximally overlapped window. Each bit of the symbol has a respective LLR, and the LLR is logarithm of a ratio of two likelihood functions, in which the likelihood functions are based on the a posteriori probabilities for each bit to have a bit value or a compliment of the bit value. In some implementations, the LLRs are calculated:

$$LLR = log ( \frac{Pr \{ bit = b \}}{Pr \{ bit = \overline{b} \}} ) , \qquad b ∈ \{ 0 , 1 \}$$

where the LLR could be positive or negative. Conventionally, the LLR is then used by the inner decoder 200 as a priori information to compute Bayesian probability for each bit of the symbols, and the inner decoder 200 forwards the computed probability to the outer decoder 204. The outer decoder 204 uses the computed probability to generate an updated LLR for the bit, and loops to the inner decoder. After a few times of iterations (usually between 4 to 20), the inner decoder 200, based on the LLR, determines a final bit value for the bit. In contrast and as explained below, the disclosed embodiments uses the LLR as an indicator to determine if a hard decision needs to be made.

As shown in the equation above, assuming an original bit value for a bit is 1 (i.e., b=1), then after some iterations between the inner decoder 200 and the outer decoder 204, the likelihood that a particular bit is a “1” is quite high and the likelihood that the bit is a “0” is substantially low. As a result, the LLR for the bit is very high. On the other hand, if the original bit value is 0, the LLR will be a negative value with a high magnitude. Once the magnitude of the LLR is larger than a threshold (predefined by the inner decoder 200 or the receiver 106), the inner decoder 200 makes a hard decision to render the bit value of the bit without further computing the probability functions for the bit in the iterative process noted above. Further, the decoding process moves on to decode the next bit of current symbol or the next symbol in the sequence of symbols 105. In other words, the inner decoder 200 ceases decoding a bit with a substantially high LLR and uses a corresponding bit value of the bit to decode subsequent bits or symbols.

For example, referring again to FIG. 3, assuming a binary PSK has been used (i.e., M=2, and one bit per symbol), if a bit value of the symbol 304 has been determined by the hard decision, the inner decoder 200 using the SISO MSDSD algorithm, in step 305, will only need to estimate the probabilities for the previous one symbol and the next two symbols in the observation window. By reducing the calculation load for at least one or more symbols, the performance to use the SISO MSDSD in disclosed embodiments may be greatly enhanced with a concurrent increase in efficiency and speed of the decoding process.

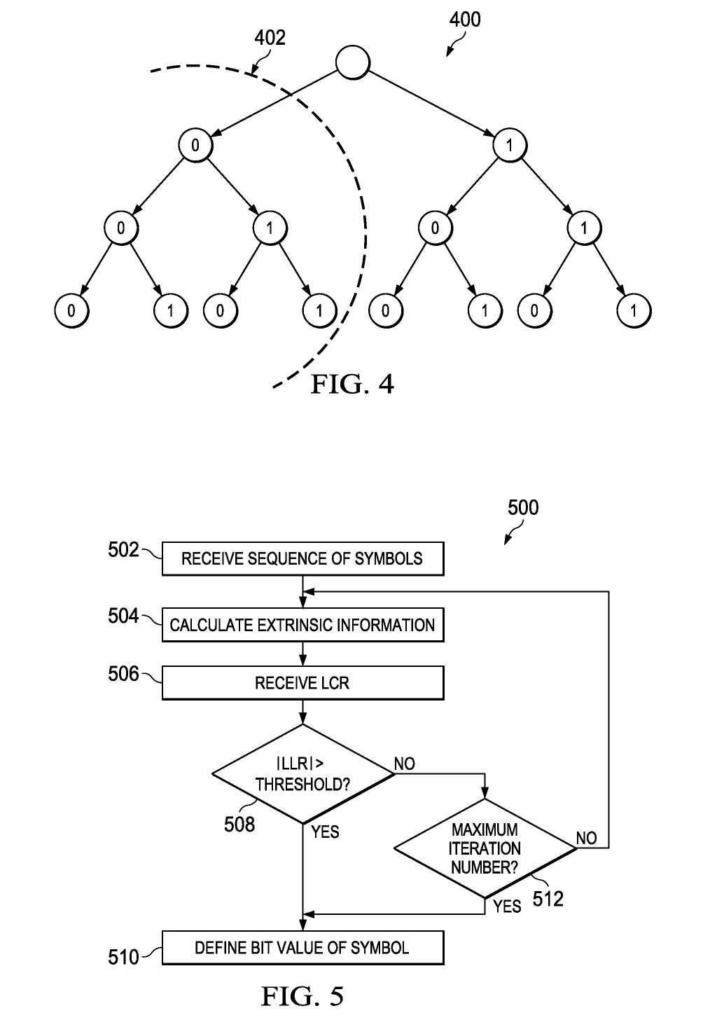

FIG. 4 shows an illustrative search tree 400 for the turbo DPSK receiver 106, assuming a binary PSK has been used (i.e., M=2), in accordance with various embodiments. The SISO MSDSD algorithm uses all available symbols inside the observation window to implement a metric-guided depth-first tree search. For example, the search tree 400 corresponds to four received symbols (i.e., m=2 and n=2) and three different symbols. Each symbol may be a “1” or “0”. Using SISO MSDSD algorithm requires searching for all 8 possible bit values in this case (i.e., 000, 001, 010, 011, 100, 101, 110, and 111). However, using the disclosed hard decision-making may prune 402 in the search tree since before the inner decoder 200 performs the search, a bit value for a symbol in the observation window has been determined due to its large enough magnitude of LLR.

The threshold used to make the hard decision for a given bit may be preconfigured to the inner decoder 200 or the receiver 106 by the manufacturer, according to a length of the sequence of symbols (e.g., 105 in FIG. 3). For example, if the length of the sequence is large, a small value of threshold will be preset by the manufacturer in order to enhance performance and efficiency of receivers. Additionally, the threshold may be set as a design parameter for users' applications, and the threshold can be calibrated by the users for suitable requirements.

FIG. 5 shows a flow diagram for a method 500 for determining a bit value of a bit in accordance with various embodiments. In block 502, the inner decoder 200 receives a sequence of symbols to be decoded, and each symbol may comprise a plurality of bits. In some preferred embodiments, in block 504, the inner decoder 200 uses the SISO MSDSD algorithm to generate extrinsic information for each bit of the symbol in the sequence. The outer decoder 204 coupled to the inner decoder 204, preferably using the BCJR algorithm, uses the extrinsic information provided by the inner decoder 200 to generate the LLR for each bit of the symbol, and then the inner decoder 200, in block 506, receives the LLR from the outer decoder 204 via a feedback loop. The LLR is used by the inner decoder 506 as an indicator to determine if a hard decision needs to be made on a bit.

Still referring to FIG. 5, if the inner decoder 200, in block 508, determines a magnitude of the LLR for a bit is greater than a threshold, the inner decoder 200, in block 510, determines the bit value for the bit and ceases decoding the bit. If the magnitude is not greater than the threshold and a maximum iteration number, in block 512, has not been reached, the inner decoder 200 loops back to block 504, to continuously calculate the extrinsic information for the bit using SISO MSDSD algorithm. The maximum iteration number used in block 512 may be referred to as a predefined number to define how many times a feedback loop from block 508 to block 504 are allowed to iterate. However, if, in block 512, the maximum iteration number has been reached, the inner decoder 200 loops to block 510.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A turbo differential phase-shift keying (DPSK) receiver, comprising:
an inner decoder configured to receive a sequence of symbols and generate extrinsic information for each bit of the received symbols; and
an outer decoder coupled to the inner decoder and configured to, using the extrinsic information as a priori information for each bit, generate a log-likelihood ratio (LLR) for each bit and provide the LLR for each bit back to the inner decoder;
wherein the inner decoder determines a bit value for a bit in a received symbol without considering neighboring symbols in the sequence, if magnitude of the LLR for the bit of the received symbol is larger than a threshold.

2. The turbo DPSK receiver of claim 1, wherein the LLR for each bit of the received symbol is a logarithm of a ratio of two likelihood functions; wherein the likelihood functions are based on probabilities to have received bits and compliments of received bits as the bit values.

3. The turbo DPSK receiver of claim 1, wherein the inner decoder is configured to make a hard decision on the bit value for the bit of the received symbol if the LLR for the bit is positive and the magnitude of the LLR is greater than the threshold; wherein the bit value is based on the probability for the bit of the received symbol.

4. The turbo DPSK receiver of claim 1, wherein the inner decoder is configured to make a hard decision on the bit value for the bit of the received symbol if the LLR for the bit is negative and the magnitude of the LLR is greater than the threshold; wherein the bit value is based on the probability for the compliment of the bit of the received symbol.

5. The turbo DPSK receiver of claim 1, wherein the threshold is predefined by the inner decoder; wherein the inner decoder defines the threshold based on a length of the sequence of symbols.

6. The turbo DPSK receiver of claim 1, wherein if the magnitude of the LLR for the bit of the symbol is not greater than the threshold, the inner decoder is configured to decode the bit using a multiple symbol differential sphere decoding (MSDSD) algorithm; wherein the MSDSD algorithm is based on estimating the corresponding objective functions for the symbol, next m, and previous n symbols in the sequence of symbols; wherein values of m and n are defined by the MSDSD algorithm, and a value of m plus n is not greater than the number of the sequence of symbols

7. The turbo DPSK receiver of claim 1, wherein the inner decoder and the outer decoder form a turbo loop configured to iteratively decode the sequence of symbols into candidate bit values.

8. The turbo DPSK receiver of claim 6, wherein the inner decoder comprises a soft-input soft-output sphere decoding module.

9. The turbo DPSK receiver of claim 6, wherein the outer decoder comprise a soft-input soft-output decoding module.

10. A system, comprising:
a differential phase-shift keying (DPSK) transmitter configured to encode a signal and transmit the encoded signal as a sequence of symbols; and
a DPSK receiver configured to decode the sequence of symbols into bit values, the DPSK receiver comprising:
a first decoder configured to:
receive the sequence of the symbols;
estimate extrinsic information for each bit of the symbols and forward the extrinsic information to a second decoder;
if magnitude of a log-likelihood ratio (LLR) received from a second decoder is greater than a threshold, determine a bit value of a bit of a received symbol, without considering neighboring symbols in the sequence of symbols; and
if the magnitude of the log-likelihood ratio (LLR) received from the second decoder is not greater than the threshold, continue to decode the bit of the received symbol and consider neighboring symbols in the sequence of symbols.

11. The system of claim 10, wherein the LLR for each bit of the received symbol is a logarithm of a ratio of two likelihood functions; wherein the likelihood functions are based on probabilities to have received bits and compliments of received bits as the bit values.

12. The system of claim 10, wherein the first decoder is configured to make a hard decision on the bit value of for the bit of the received symbol, if the LLR for the bit of the received symbol is positive and the magnitude of the LLR is greater than the threshold; wherein the bit value is based on the probability for the received symbol.

13. The system of claim 10, wherein the first decoder is configured to make a hard decision on the bit value of the bit of the received symbol if the LLR for the bit of the received symbol is negative and the magnitude of the LLR is greater than the threshold; wherein the bit value is based on the probability for the compliment of the received symbol.

14. The system of claim 10, wherein the threshold is predefined by the first decoder; wherein the inner decoder defines the threshold based on a length of the sequence of symbols.

15. The system of claim 10, wherein if the LLR, received from the second decoder, for the bit of the received symbol is not greater than the threshold, the first decoder is configured to decode the bit of the received symbol using a multiple symbol differential sphere decoding (MSDSD) algorithm; wherein the MSDSD algorithm is based on estimating the corresponding probability density functions for the received symbol, next m, and previous n symbols in the sequence of symbols; wherein values of m and n are defined by the MSDSD algorithm, and a value of m plus n is not greater than the number of the sequence of symbols.

16. The system of claim 10, wherein the first decoder and the second decoder form a turbo loop configured to iteratively decode the sequence of symbols, received from the transmitter.

17. The system of claim 10, wherein the first decoder of the DPSK receiver comprises a soft-input soft-output sphere decoding module.

18. The system of claim 10, wherein the second decoder of the DPSK receiver comprises a soft-input soft-output module.

19. A method, comprising:
receiving, by an inner decoder of a differential phase-shift keying (DPSK) receiver, a sequence of symbols;
calculating, by the inner decoder, extrinsic information for each bit of the symbols and sending the extrinsic information to an outer decoder;
receiving, by the inner decoder, a log-likelihood ratio (LLR) for each bit generated by the outer decoder; and
determining, by the inner decoder, a bit value for a bit of a received symbol without considering neighboring symbols in the sequence of symbols, if magnitude of the LLR for the bit of the received symbol is greater than a threshold.

20. The method of claim 19, further comprising if the magnitude of the LLR for the bit of the received symbol is not greater than the threshold, decoding, by the inner decoder, the bit of the received symbol using a multiple symbol differential sphere decoding (MSDSD) algorithm; wherein the MSDSD algorithm is based on estimating the corresponding probability density functions for the received symbol, next m, and previous n symbols in the sequence of symbols.
